(19) United States
(12) Patent Application Publication
(10) Pub. No.: US 2007/0290413 A1
(43) Pub. Date: Dec. 20, 2007

(54) Mold For A Container Blow Molding Machine And Method Of Producing Containers Using One Such Mold

(75) Inventor: Jules Tonga, Octeville-Sur-Mer (FR)

Correspondence Address: SUGHRUE MION, PLLC, 2100 PENNSYLVANIA AVENUE, N.W., SUITE 800, WASHINGTON, DC, 20037, US

(73) Assignee: Sidel Participations, Octeville Sur Mer (FR)

(21) Appl. No.: 11/667,378

(22) PCT Filed: Oct. 27, 2005
(86) PCT No.: PCT/FR05/02698

§ 371 Date: Jun. 14, 2007

(30) Foreign Application Priority Data
Nov. 10, 2004 (FR) 04/11,998

(51) Int. Cl. B29C 49/54

(52) U.S. Cl. 264/523; 425/531

(57) ABSTRACT

A mold for a machine which is used for the blow molding of containers from performs. The inventive mold includes a wall defining a cavity that is intended to receive a preform. In addition, the mold includes at least one mold insert which is equipped with a lug and which is mounted such that it can move in relation to the wall by means of a cam system, between: an out position in which the lug projects out at least partially from the wall into the cavity, and a retracted position in which the lug is retracted into the wall. The invention also relates to a method of producing a container by means of blow molding using one such mold.

### FIELD OF THE INVENTION

The invention relates to blow molding containers from preforms, generally made of thermoplastic material.

### BACKGROUND OF THE INVENTION

It will be recalled that the blow molding of a container takes place in a mold of which the wall defines a cavity into which the preform is introduced, said preform, during blow molding, conforming in shape with the wall under the action of the increased gas pressure which prevails in the preform, which is previously heated so as to allow the plastic deformation thereof.

A need has been expressed for certain applications for providing the containers with a handle which defines, with the body of the container, an aperture allowing the free passage of the hand.

Currently, the manufacture of this type of container may be carried out according to two specific techniques.

The first consists in injection-molding the container, the handle being formed from a block with the body of the container to which it is attached. However, as already indicated, the present application relates to the technique of blow molding. In addition, the injection-molding technique is, in this case, outside the subject of the invention.

The second technique consists in producing the body of the container by blow molding around a detachable handle, introduced into the mold prior to the blow molding.

This technique, disclosed in the European patent issued under the number EP-1 204 524 and originating from the applicant, has shown that it is possible to produce a container with a handle by blow molding. However, it requires complex and costly kinematics for the positioning of the handle, the synchronization of all the operations proving to be particularly difficult to master and generating, in spite of the forces produced, a reduction in the speed of the operation.

It has recently been proposed to form directly in the container, during blow molding, hollow impressions able subsequently to receive a handle by a snap connection.

According to this technique, disclosed in the American patent U.S. Pat. No. 5,649,612, retractable protuberances are formed in the mold cavity and about which the container is formed. During the blow molding, these protuberances are displaced further to the front in the cavity to form completely the aforementioned impressions.

If, in theory, this technique allows impressions to be made on the container allowing the mounting of the handle, in reality there is a risk of perforating the wall of the container by means of the protuberances during the blow molding.

Moreover, from a structural point of view, the protuberances are formed at the ends of mobile arms mounted on rams which ensure their displacement. Here again, this technique, which is attractive in theory, is not able to be easily put into practice. More specifically, the arms have the tendency, due to their significant overhang, to be braced and to jam during their displacement. In fact, at their end shaped as a protuberance a force is exerted, under the pressure prevailing in the container during the blow molding, which opposes the thrust force of the ram which is exerted at the opposing end, the resultant of these forces being a torque which tends to make the arm pivot about an axis perpendicular to the direction of displacement thereof.

A further technique, disclosed in the American patent application published under the number US 2002/0195749 proposes a method for molding an article according to which a sleeve is initially introduced into the mold cavity which extends around a rod which is fixed relative to the mold and of which the external diameter corresponds to the internal diameter of an impression to be formed in the wall of the article, then, after molding, to allow the article to rest for a given duration, before retracting the sleeve so that the wall of the article conforms to the shape of the rod.

An unmolding problem occurs with this technique, as the rod remains fixed relative to the mold. In these conditions, specific gripping means have to be provided to separate the article from the mold at the end of the blow molding, which increases both the costs of the mold and the duration of the cycle.

The inventors have endeavored, whilst remaining within the technique of blow molding, to propose an alternative solution to the known techniques, which makes it possible in particular to resolve the aforementioned problems.

To this end, the inventors propose, in the first instance, a mold for a machine for blow molding containers from preforms, this mold comprising a wall defining a cavity intended to receive a preform and comprising at least one mold insert which, provided with a lug, is displaceably mounted relative to the wall, between:

an extended position in which the lug projects at least partially relative to the wall, into the cavity, and

a retracted position in which the lug is retracted into the wall,

said mold being characterized in that the insert is in the form of a cam follower, the mold comprising an actuating mechanism, which comprises a cam which is mounted mobile relative to the wall, between:

an inactive position in which it allows the insert to adopt its retracted position, and

an active position in which it displaces the insert toward its extended position.

During blow molding, the material of the preform conforms to the shape of the projecting lug which thus forms in the body of the container a hollow impression with which ultimately a detachable grip handle of the container cooperates. It is noteworthy that the cam/cam follower mechanism allows a more reliable functioning of the mold to be obtained.

According to one embodiment, as the cavity extends along a principal axis, the lug extends, in the extended position, substantially parallel to this axis, by being for example mounted mobile in translation relative to the wall of the mold.

According to one embodiment, the wall of the mold has a protuberance toward the inside of the cavity, a protuberance in which the insert is received.

The insert is, for example, displaceable in translation in a direction parallel to a principal axis of the mold cavity, the cam being, in turn, displaceable in translation in a direction perpendicular to this principal axis.

According to one embodiment, the cam has a cam surface which is oblique relative to the direction of displacement of the cam which cooperates with a bearing surface made on the cam follower and which is oblique relative to the direction of displacement of the cam follower.

The cam follower is, for example, provided with at least one pin which projects perpendicularly to the direction of displacement of the cam follower, this pin cooperating with a groove made in the cam parallel to the cam surface.

The actuating mechanism may comprise a return spring which urges the cam toward its inactive position, in addition to, for example, a ram provided with a rod, at one end of which the cam is mounted.

The mold may also comprise a return spring which urges the insert toward its retracted position.

According to one embodiment, the mold comprises, in practice, two inserts each provided with a lug and jointly displaceable relative to the wall, between:

an extended position in which the lugs project both at least partially relative to the wall into the cavity, and

a retracted position in which the lugs are both retracted into the wall.

The inventors also propose, in the second instance, a method for producing a container by blow molding from a preform made of thermoplastic material, said method using a mold comprising a wall defining a cavity intended to receive a preform, in addition to at least one mold insert which, provided with a lug, is displaceably mounted relative to the wall, between:

an extended position in which the lug projects at least partially relative to the wall, into the cavity, and

a retracted position in which the lug is retracted into the wall,

this method comprising the steps consisting of:

introducing the preform into the cavity;

placing the mold insert in its extended position;

forming the container by blow molding or stretch blow molding of the preform in the cavity so as to allow a complementary impression of said insert on the formed container;

once the container is formed, placing the insert mold in its retracted position;

removing the container thus formed from the mold.

According to one embodiment, the step for positioning the insert is carried out during the blow molding step before the material of the preform reaches the lugs.

The method finally comprises, for the finishing of the product, a step consisting, after the formation of the container, in mounting thereon a detachable handle provided with at least one claw capable of cooperating in a removable manner with a hollow impression formed, in the wall of the container, by the lug of the insert during the step of forming the container.

### BRIEF DESCRIPTION OF THE DRAWINGS

Further objects and advantages of the invention will emerge from viewing the description made below, by referring to the accompanying drawings, in which:

FIG. 1 is a partial perspective view showing a mold according to the invention, in the retracted position of the inserts;

FIG. 2 is a perspective view of the mold of FIG. 1 in the same position, according to a further viewing angle;

FIG. 3 is a sectional view of a mold according to the invention, in the retracted position of the mold inserts;

FIG. 4 is a sectional view according to the plane IV-IV of FIG. 3;

FIG. 5 is a view similar to FIG. 3 in the extended position of the mold inserts;

FIG. 6 is a sectional view according to the plane VI-VI of FIG. 5;

FIGS. 7 and 8 are perspective views showing the mold inserts of the mold of the preceding figures, associated with their actuating mechanism; and

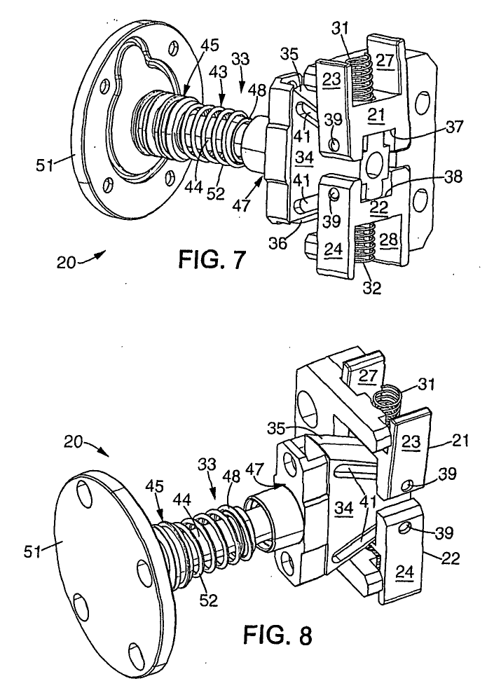

FIGS. 9 and 10 illustrate the step of mounting a detachable handle on a container formed by means of a mold as shown in the preceding figures.

### DETAILED DESCRIPTION OF THE EMBODIMENTS

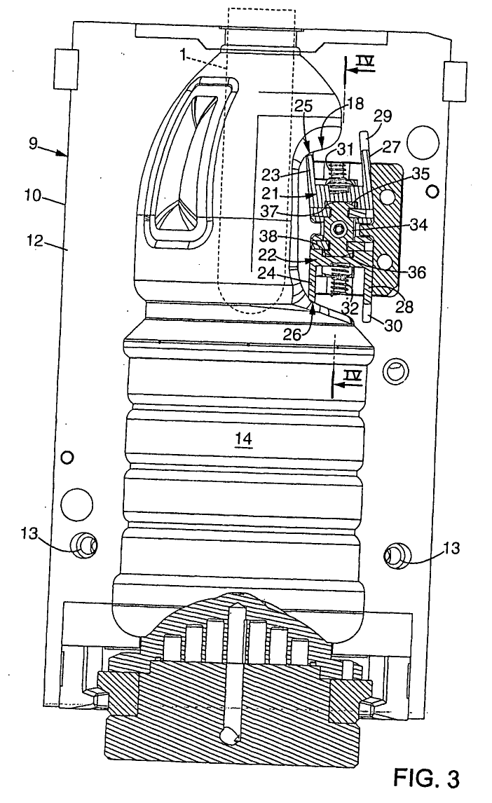

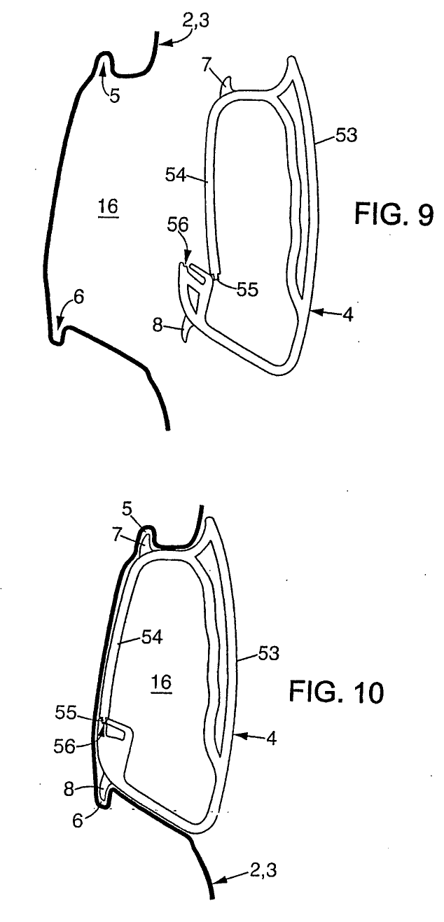

It is desirable to produce by blow molding or by stretch blow molding from a preform 1 made of thermoplastic material (said preform, as shown in dotted lines in FIG. 3, is in this case a preform previously produced by injection molding), a container 2 having a body 3 onto which a detachable handle 4 is then hooked, mounted by a snap connection, as shown in FIGS. 9 and 10.

In order to allow the hooking of the handle 4 onto the body 3 of the container 2, it is desirable to form in the body 3 at least one hollow impression 5, 6 with which a claw 7, 8 of the handle 4 cooperates.

More specifically, according to one embodiment illustrated in FIGS. 9 and 10, it is desirable to form in the body 3 of the container 2 two opposing impressions 5, 6 i.e. of which the respective concavities are opposing, intended to receive two claws 7, 8 of the handle 4, with which they are complementary.

It will ultimately be explained how the mounting of the handle 4 is carried out on the body 3 of the container 2; the means intended to form the impressions 5, 6 and their implementation now being detailed.

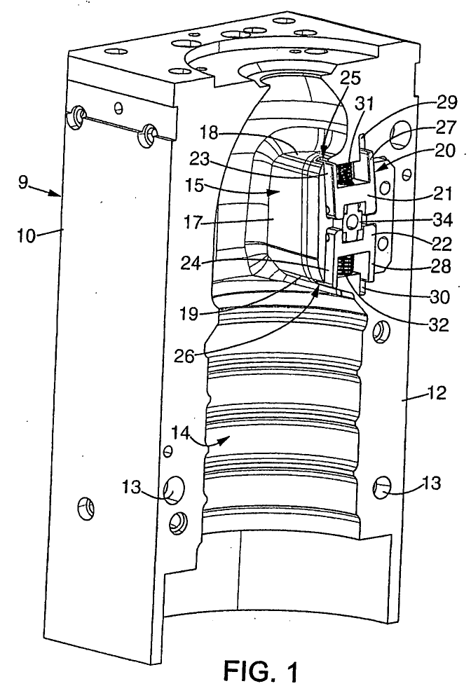

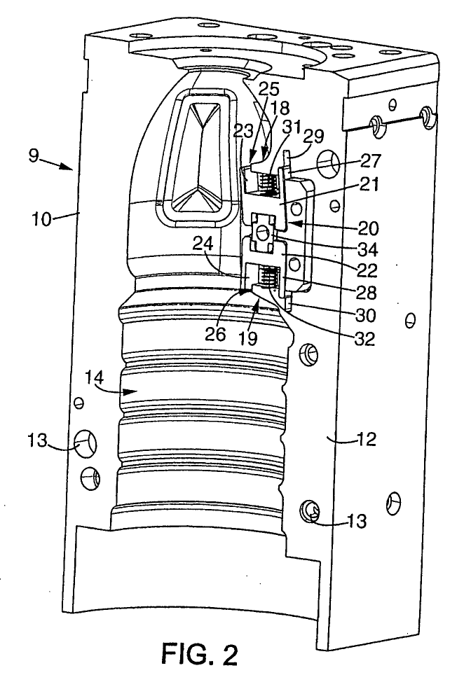

In FIGS. 1 to 6 a mold 9 is shown which is intended to equip a blow molding machine (not shown) for forming containers 2.

This mold 9 is formed by assembling two half molds 10, 11 of which one 10 is shown alone in FIGS. 1, 2, 3 and 5.

The mold 9 comprises a wall 12, for example made in an aluminum alloy, and with pipes 13 cut through for the circulation of a coolant liquid for the heating or cooling of the mold 9. This wall 12 defines a cavity 14 made by precision machining, intended to receive the preform 1, as illustrated in FIG. 3, and of which the shape corresponds to that of the container 2 to be formed.

As is visible in FIG. 1, the cavity 14 is generally distributed about a principal axis X which extends according to the greatest dimension of the cavity 14, (i.e. of the container 2) with the exception of an area in which the wall 12 has a protuberance is which projects into the cavity 14, this protuberance 15 being intended to form on the body 3 of the container 2, during blow molding, a hollow protected area 16 of sufficient dimension to receive the hand of a user, a protected area 16 in which the handle 4 will be mounted.

The protuberance 15 has a lateral face 17 which is substantially planar and parallel to the principal axis X of the cavity 14, extended upward and downward, respectively through an upper face 18 and a lower face 19 which are also planar, but oblique relative to the principal axis X.

The mold 9 comprises a specific device 20 for the formation of impressions 5, 6 mounted in the wall 12, and which comprises two inserts 21, 22 known as mold inserts, namely an upper insert 21 and a lower insert 22, received in the protuberance 15 and each provided with a respective lug 23, 24, each of these inserts being mounted in the wall 12 by being displaceable relative to said wall, between:

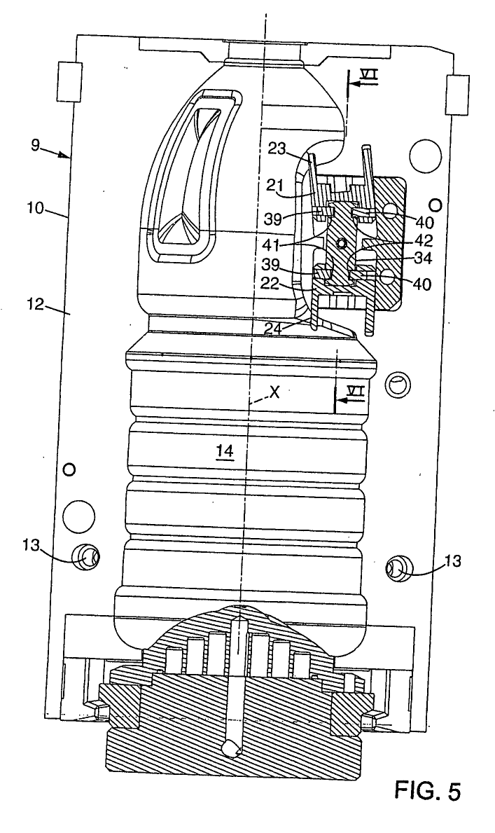

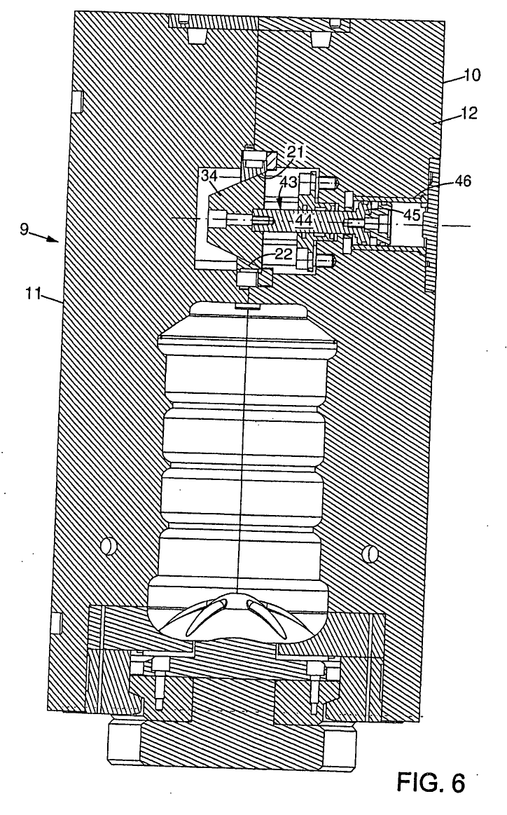

an extended position in which each lug 23, 24 projects at least partially relative to the wall 12 into the cavity 14, substantially parallel to the principal axis X (FIGS. 5 and 6) and

a retracted position in which each lug 23, 24 is retracted into the wall 12 (FIGS. 1 to 4).

In the extended position, the lug 23 of the upper insert 21 projects relative to the upper face 18 of the protuberance 15 whilst the lug 24 of the lower insert 22 projects relative to the lower face 19 of the protuberance 15.

More specifically, each insert 21, 22 is mounted mobile in translation relative to the wall 12, substantially parallel to the principal axis X of the cavity 14. The respective movements of the inserts 21, 22 are both synchronized and opposing. In other words, the inserts 21, 22 simultaneously occupy their extended position on the one hand, and their retracted position on the other hand, the passage from one to the other of these positions being carried out simultaneously for the two inserts 21, 22.

The guiding of each insert 21, 22 is ensured, on the one hand, by the lug 23, 24 which passes through a complementary aperture 25, 26 formed in the wall 12 and opening out into the cavity 14 and, on the other hand, by a finger 27, 28 received in a complementary groove 29, 30 formed in the wall 12 of the mold 9. Return springs 31, 32 continually urge the inserts 21, 22 toward their retracted position.

According to one embodiment illustrated in the figures, the inserts 21, 22 are cam followers, the device 20 comprising an actuating mechanism 33 provided with a cam 34 acting jointly on the two inserts 21, 22 and mounted in the wall 12 by being mobile relative to said wall between:

an inactive position in which the cam 34 allows the inserts 21, 22 to occupy their retracted position, and

an active position in which the cam 34 pushes back the inserts 21, 22 toward their extended position.

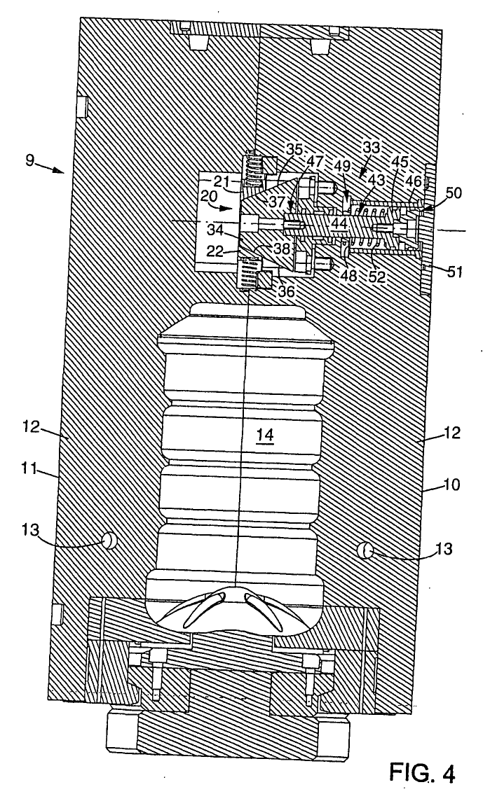

According to an embodiment illustrated in the figures, and as this is more particularly visible in FIGS. 4 and 6, the cam 34 may be displaced in translation in a direction perpendicular to the principal axis X.

As is shown in particular in FIG. 6, the cam 34 has a substantially trapezoidal profile and has two cam surfaces 35, 36 which are oblique relative to the direction of displacement of the cam 34, each of these surfaces 35, 36 cooperating with a bearing surface 37, 38, made on each insert 21, 22 opposite the lug 23, 24 and oblique relative to the direction of displacement of the insert 21, 22.

In order to allow precise guiding of the inserts 21, 22, each insert is provided with at least one pin 39, 40 which projects perpendicularly to the direction of displacement of the insert 21, 22, this pin 39, 40 cooperating with a groove 41, 42 made in the cam 34 parallel to the cam surface 35, 36. In practice, two pins 39, 40 are in fact provided on both sides of each insert 21, 22, the cam 34 being, in turn, provided with four grooves 41, 42 symmetrical in pairs, each capable of receiving a pin 39, 40.

As is clearly visible in FIGS. 4 and 6, the actuating mechanism 33 comprises a pneumatic ram 43 provided with a rod 44 of which a first end 45 is formed in a piston mounted slidably in a cylinder 46 formed in the wall 12, the cam 34 being mounted on a second end 47 of the rod 44, opposite the first 45.

A washer 48 closes one end 49 of the cylinder 46, located on the side of the cam 34, an opposing end 50 of the cylinder 46 being closed by a plate 51 fixedly attached through the outside of the mold 9 onto the wall 12. A return spring 52 mounted in the cylinder 46 and interposed between the first end 45 shaped as a piston of the rod 44 of the ram 43 and this washer 48, continually urge the cam 34, by means of the rod 44, toward its inactive position, as illustrated in FIG. 4.

The method for producing the container 2 is now disclosed, using the mold 9 which has been described above.

This method firstly comprises a step of introducing the preform 1 into the cavity 14 whilst, as the cam 34 is in its inactive position, the inserts 21, 22 are in their retracted position (FIG. 3).

This conventional step of introduction is carried out in the known manner, the mold 9 being open (i.e. the two half molds 10, 11 are separated from one another), the preform 1, which is hot, being moved transversely by means of an appropriate transfer device such as a transfer arm (not shown).

Once the mold 9 is closed again, then the blow molding or the stretch blow molding of the preform is carried out in a manner known per se. The actuating mechanism 33 is controlled during the blow molding or the stretch blow molding of the preform 1 so as to remove the lugs 23, 24 before said lugs have been reached by the container during the course of forming.

To this end, the cylinder 46 may be attached pneumatically, by means of a bypass to the feed circuit of the preform 1 (typically the feed circuit of the blow molding pipes in the machines is of the type of those of the applicant), the actuating of the ram 43 being thus carried out as soon as the pressurization of the preform 1 takes place.

Taking account of its plasticity, the material of the container 2 comes into contact with the wall of the cavity 14 until around the lugs 23, 24, with which it conforms in shape to form the impressions 5, 6 (thus the complementary impressions of the lugs 23 and 24) intended to receive ultimately the claws 7, 8 of the handle 4.

At the end of the blow molding or the stretch blow molding, the pressure in the container 2 is brought to atmospheric pressure, the inserts 21, 22 being thus brought to their retracted position by a combined action of the return springs 31, 32 and the reverse movement of the ram 43 to allow the unmolding of the container 2.

The mold 9 is then opened, from which the container 2 thus formed is removed, and on the body 3 of which the handle 4 is then fixed. Said handle comprises a body 53 in the form of an open ring, provided with a flexible tongue 54 carrying at one free end a tooth 55 which is clipped into a complementary housing 56 formed in one part of the body 53 opposite. Thus the handle 4 may adopt two configurations, namely:

an open configuration, shown in FIG. 9, in which the tongue 54 is folded back inside the loop formed by the body 53, and where the tooth 55 is located at a distance from its housing 56; in this configuration, under the action of the elasticity of the handle 4, the distance separating the ends of the claws 7, 8 is less than the distance separating their respective impressions 5, 6, so as to allow the introduction without force of the handle 4 in the protected area 16, and

a closed configuration shown in FIG. 10, in which, after having positioned the handle 4, and pushed the tongue 54 until the tooth 55 is clipped into its housing 56, the claws 7, 8 are received undetachably in their impressions 5, 6 except for when replacing the handle 4 in its open configuration by the action on the tongue 54, for example to allow the same handle 4 to be reused on a plurality of successive containers as said containers are emptied of their contents.

It is understood that it is thus possible to produce a container 2 with a detachable handle 4 easily by blow molding, said handle being mounted after the body 3 of the container 2 has been formed.

On the one hand, this does not result in any arrangements which lead to any excessive complications in the production and structure of the mold. On the other hand, the method which has been disclosed above does not cause a reduction in the speed of the operation relative to conventional blow molding, the steps of extending and retracting the mold inserts being carried out in concurrent operation time during the usual steps of blow molding (stretching, degassing).

1. A mold for a machine for blow molding containers from preforms, this mold comprising a wall defining a cavity intended to receive a preform, in addition to at least one mold insert which, provided with a lug, is displaceably mounted relative to the wall between:
an extended position in which the lug projects at least partially relative to the wall, into the cavity, and
a retracted position in which the lug is retracted into the wall,
said mold being characterized in that the mold insert is a cam follower, and in that the mold comprises an actuating mechanism which comprises a cam mounted mobile relative to the wall, between:
an inactive position in which the cam allows the insert to adopt its retracted position, and
an active position in which the cam pushes the insert toward its extended position.

2. The mold as claimed in claim 1, characterized in that as the cavity extends along a principal axis, the lug extends, in the extended position, substantially parallel to the principal axis.

3. The mold as claimed in claim 1, characterized in that the mold insert is mounted mobile in translation relative to the wall of the mold.

4. The mold as claimed in claim 1, characterized in that the wall of the mold has a protuberance toward the inside of the cavity and in that the mold insert is received in this protuberance.

5. The mold as claimed in claim 4, characterized in that the insert is displaceable in translation in a direction parallel to a principal axis of the cavity and in that the cam is displaceable in translation in a direction perpendicular to this principal axis.

6. The mold as claimed in claim 5, characterized in that the cam has a cam surface which is oblique relative to the direction of displacement of the cam which cooperates with a bearing surface made on the insert and which is oblique relative to the direction of displacement of the insert.

7. The mold as claimed in claim 6, characterized in that the insert is provided with at least one pin which projects perpendicularly to the direction of displacement of the insert, said pin cooperating with a groove made in the cam parallel to the cam surface.

8. The mold as claimed in claim 1, characterized in that the actuating mechanism comprises a return spring which urges the cam toward its inactive position.

9. The mold as claimed in claim 1, characterized in that the actuating mechanism comprises a ram provided with a rod, at one end of which the cam is mounted.

10. The mold as claimed in claim 1, characterized in that it comprises a return spring which urges the insert toward its retracted position.

11. The mold as claimed in claim 1, characterized in that it comprises two inserts each provided with a lug and jointly displaceable relative to the wall, between:
an extended position in which the lugs project both at least partially relative to the wall into the cavity, and
a retracted position in which the lugs are both retracted into the wall.

12. A method for producing a container by blow molding from a preform made of thermoplastic material, said method using a mold comprising a wall defining a cavity intended to receive a preform, in addition to at least one mold insert which, provided with a lug, is displaceably mounted relative to the wall, between:
an extended position in which the lug projects at least partially relative to the wall, into the cavity, and
a retracted position in which the lug is retracted into the wall,
said method comprising the steps consisting of:
introducing the preform into the cavity;
placing the mold insert, which is a cam follower, in its extended position using an actuating mechanism which comprises a cam mounted mobile relative to the wall, between an inactive position in which the cam allows the insert to adopt its retracted position, and an active position in which the cam pushes the insert toward its extended position;
forming the container by blow molding or stretch blow molding of the preform in the cavity so as to allow at least one hollow impression on the formed container, complementary to said lug;
once the container is formed, placing the mold insert in its retracted position;
removing the container thus formed from the mold.

13. The method as claimed in claim 12, characterized in that the step for positioning the insert is carried out during the blow molding step before the material of the preform reaches the lugs.

14. The method as claimed in claim 12, comprising a step consisting, after the formation of the container, in mounting thereon a detachable handle provided with at least one claw capable of cooperating in a removable manner with a hollow impression formed, in the body of the container by the lug of the mold insert during the forming of the container.
